(19) United States
(12) Patent Application Publication
(10) Pub. No.: US 2020/0156241 A1
(43) Pub. Date: May 21, 2020

(54) AUTOMATION SAFETY AND PERFORMANCE ROBUSTNESS THROUGH UNCERTAINTY DRIVEN LEARNING AND CONTROL

(71) Applicant: Ford Global Technologies, LLC, Dearborn, MI (US)

(72) Inventor: Iman SOLTANI BOZCHALOOI, Sacramento, CA (US)

(73) Assignee: Ford Global Technologies, LLC, Dearborn, MI (US)

(21) Appl. No.: 16/197,649

(22) Filed: Nov. 21, 2018

(51) Int. Cl. B25J 9/16

(52) U.S. Cl. CPC B25J 9/163; B25J 9/1697; G05B 2219/32335; G05B 2219/42156; G05B 2219/33321

(57) ABSTRACT

A control and learning module for controlling a robotic arm includes at least one learning module including at least one neural network. The at least one neural network is configured to receive and be trained by both state measurements based on measurements of current state and observation measurements based on observation data during an initial learning phase. The at least one learning module is further configured to be re-tuned by updated observation data for improved performance during an operations and secondary learning phase when the robotic arm is in normal operation and after the initial learning phase.

### FIELD

The present disclosure relates to systems and methods for controlling automation systems, and more particularly to machine learning and robust control systems and methods in robotics.

### BACKGROUND

The statements in this section merely provide background information related to the present disclosure and may not constitute prior art.

Machine learning techniques have been used in automation systems. When used in automotive manufacturing lines, the automation systems further require performance and safety robustness in handling mission critical tasks. Aside from the human safety concerns, incidents may lead to downtime on production lines, leading to thousands of dollars of losses. Deep neural networks are one of the machine learning techniques that have been used in automation systems. Conventional deep learning techniques, however, fail to provide any safety and performance robustness guarantees and may deter manufacturers from adopting the deep learning techniques in mission critical automation tasks.

In addition to performance and safety robustness concerns, ability to adapt to the unknown environmental variables and their corresponding variability is another much-needed characteristic of the new generation of automation tools. Therefore, it is desirable to allow the information captured during normal interactions with the environment in machine learning process to be used to improve upon perception and control policies in an unsupervised fashion. Most importantly, the learning process should be implemented in a safe fashion to avoid costly incidents

The above-mentioned problems and associated needs are addressed in the present disclosure.

### SUMMARY

In one form of the present disclosure, a control and learning module for controlling a robotic arm includes at least one learning module including at least one neural network. The at least one neural network is configured to receive and be trained by both state measurements based on measurements of current state and observation measurements based on observation data during an initial learning phase. The at least one learning module is further configured to be re-tuned by updated observation data for improved performance during an operations and secondary learning phase when the robotic arm is in normal operation and after the initial learning phase.

In other features, the state measurements represent actual current state obtained by sensors. The at least one neural network is represented as a Bayesian neural network and is configured to generate an output relating to an output task and a variance associated with the output. The variance is a measure of uncertainty relating to reliability of the output task.

The at least one learning module includes a state estimation module configured to provide an estimated state based on only the observation measurements and a dynamics modeling module configured to generate a dynamics model and a dynamics model output variance, which represents an uncertainty of the dynamics model. The state estimate module is configured to output a first estimated current state and a variance associated with the first estimated current state. The dynamics modeling module is configured to output a second estimated current state. The state estimation module and the dynamics modeling module are each configured to receive an input relating to a difference between the first estimated current state and the second estimated current state to improve performance during the operations and secondary learning phase.

The estimated state can include estimated positions and velocities of obstacles and target objects in an environment or other information (external to the robot) that fully define the robot with respect to the environment. The control and learning module further includes a control policy module, an optimal control module and a reachability analysis module. The control policy module is configured to generate a control policy command and a control policy variance associated with the control policy command based on the estimated current state from the state estimation module, only during the operations and secondary learning phase. The optimal control module is configured to generate an optimal control command based on the dynamics model from the apriori available models or those learned by the dynamics modeling module and the state measurements or the estimated states. The optimal control module may override the control policy command from the control policy module when the control policy variance is larger than a predefined variance threshold value corresponding to a case where the control policy is uncertain about its generated output.

The reachability analysis module may receive the state measurements, the dynamics model parameters and the associated output or parameter variance from the dynamics modeling module, and determine whether the current state is in a safe state. The reachability analysis module may generate a robust control command overriding the optimal control command from the optimal control module or the control policy (if active) when the reachability analysis module determines that the current state is in an unsafe state.

The state estimation module, the dynamics modeling module, and the control policy module each include a neural network which receives training in both the initial learning phase and the operations and secondary learning phase and each output a variance representing uncertainty of each of the state estimation module, the dynamics modeling module, and the control policy module. The dynamics modeling module includes a preliminary dynamics model and a complementary dynamics model, the preliminary dynamics model being predetermined and providing state prediction based on existing knowledge about system dynamics of the robotic arm. The complementary dynamics model may generate a correction parameter to correct the state prediction provided by the preliminary dynamics model and the dynamics model variance associated with the correction parameter.

It should be noted that the features which are set out individually in the following description can be combined with each other in any technically advantageous manner and set out other variations of the present disclosure. The description additionally characterizes and specifies the present disclosure, in particular in connection with the figures.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of an automation system including a control and learning module constructed in accordance with the teachings of the present disclosure;

FIG. 2 is a flow chart of an initial learning phase of the control and learning module constructed in accordance with the teachings of the present disclosure; and

FIG. 3 is a flow chart of an operations and secondary learning phase of the control and learning module constructed in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In this application, including the definitions below, the term “module” or the term “controller” may be replaced with the term “circuit”. The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

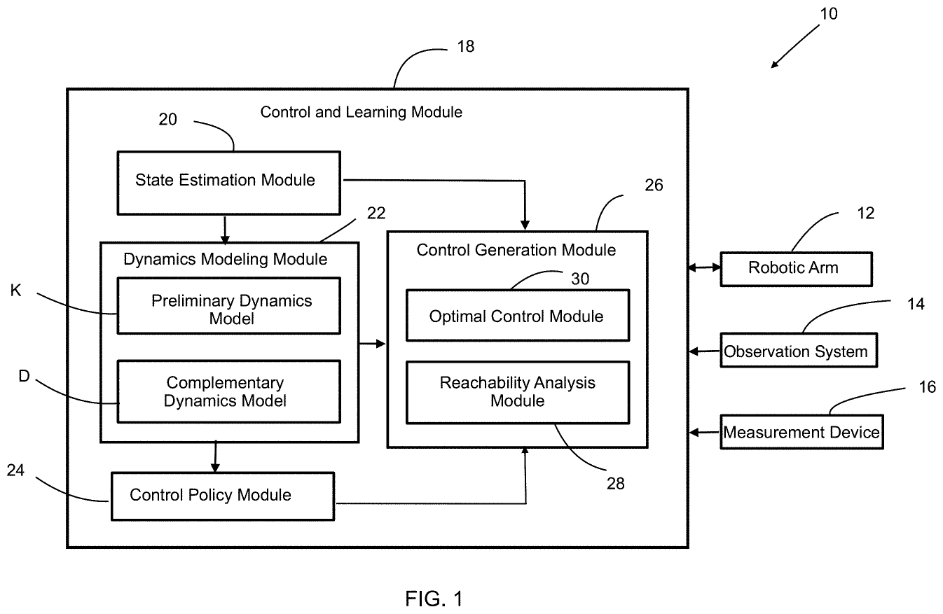

Referring to FIG. 1, an automation system 10 constructed in accordance with the teachings of the present disclosure incudes a robotic arm 12, an observation system 14, a measurement device 16, and a control and learning module 18 for controlling the robotic arm 12 to achieve a safe and effective operation. The control and learning module 18 enables the robotic arm 12 to perform mission-critical tasks, such as assembling tasks, manipulation tasks or inspection tasks on a production line.

The observation system 14 may include a camera for providing observation measurements, e.g., in the form of camera images or visual data, to the control and learning module 18. In another form, the observation system 14 may include LiDARs or RADARs. The observation system 14 represents a general observation unit which may or may not provide the system states directly. If direct access to state values is not available, the observation measurements provided by the observation system 14 need to be further processed and analyzed to provide an estimated state value. The measurement device 16 may include a plurality of auxiliary sensors to directly capture and measure state values. Therefore, the measurement device 16 provides state measurements representing the actual value of the current state.

The control and learning module 18 includes a state estimation module 20, a dynamics modeling module 22, a control policy module 24, and a control generation module 26. The state estimation module 20 is configured to provide estimated current state, such as estimated positions of all obstacles and target objects in the environment, solely based on the observation measurements from the observation system 14. The dynamics modeling module 22 is configured to generate a dynamics model for controlling the robotic arm 12. The dynamics modeling module 22 includes a preliminary dynamics model K, and a complementary dynamics model D. The preliminary dynamics model K is created based on all available information (i.e., existing knowledge) about the system dynamics of the robotic arm 12 in isolation, i.e., no interaction with the environment. The complementary dynamics model D is configured to learn the unknown portion of the preliminary dynamics model K during an initial learning phase.

The control policy module 24 is configured to learn a robust and optimal control policy by using deep learning capabilities in order to command various actuators, such as robot servos, to accomplish a task in a satisfactory fashion when needed.

The state estimation module 20, the dynamics modeling module 22, the control policy module 24 each includes a deep learning network. In one form, the deep learning networks may be Bayesian neural networks, which are a type of probabilistic graphical model that uses Bayesian inference for probability computations. The Bayesian neural network assumption can be implemented in a fashion similar to common regularization techniques like dropout and is not expected to increase the computational complexity of such a network significantly. The difference with conventional dropout here is that the randomized nulling of different parameters is done during inference as well as in the training.

The control and learning module 18 undergoes two learning phases: an initial learning phase and an operations and secondary learning phase. During the initial learning phase, some and incomplete information about the robotic arm dynamics (including its interaction with the objects in the environment) is provided to the control and learning module 18. It is assumed that correct current states are provided to the control and learning module 18 by the measurement device 16. For example, the correct current states may be the accurate position of a door hinge on a door assembly task on a vehicle body, which may be obtained by direct measurement by the measurement device 16. The measurement device 16 and the information obtained by the measurement device 16 may not be available during the normal operation of the robotic arm 12 due to practical and financial limitations, but may be accommodated into a single experimental setup designed for initial training. The observation measurements by the observation system 14 are available during both the initial learning phase and the normal operation of the robotic arm 12. During the initial learning phase, all three deep learning networks of the state estimation module 20, the dynamics modeling module 22, and the control policy module 24 use the available information for training. However, the control policy module 24 does not effectuate any interaction with the environment in the initial learning phase. In the initial learning phase, the robotic control is generated through conventional robust and optimal control techniques and based on the state measurements.

The control generation module 26 is configured to generate a robust control for the robotic arm 12. In the initial learning phase, the control generation module 26 relies on the results of the dynamics modeling module 20 and available direct state measurements from the measurement device 16. In the initial learning phase, the control policy module 24 does not contribute to the robot operation and is solely learning. In the operations and secondary learning phase, however, the control generation module 26 functions based on the learning results from all of the three deep learning networks of the state estimation module 20, the dynamics modeling module 22, and the control policy module 24. The control generation module 26 includes a reachability analysis module 28 for performing safety evaluation of the current state and an optimal control module 30 for generating an optimal control command.

During the operations and secondary learning phase, the robotic arm 12 is in normal operation and controlled by the control and learning module 18 based on the dynamics model learned and generated during the initial phase. Simultaneously, the control and learning module 18 continuously modifies the dynamics modelling module or the state estimation module based on the discrepancies between estimated states provided by the dynamics modeling module 22 and the estimated current states provided by the state estimation module 20 to ensure a safe and improved performance of the robotic arm 12.

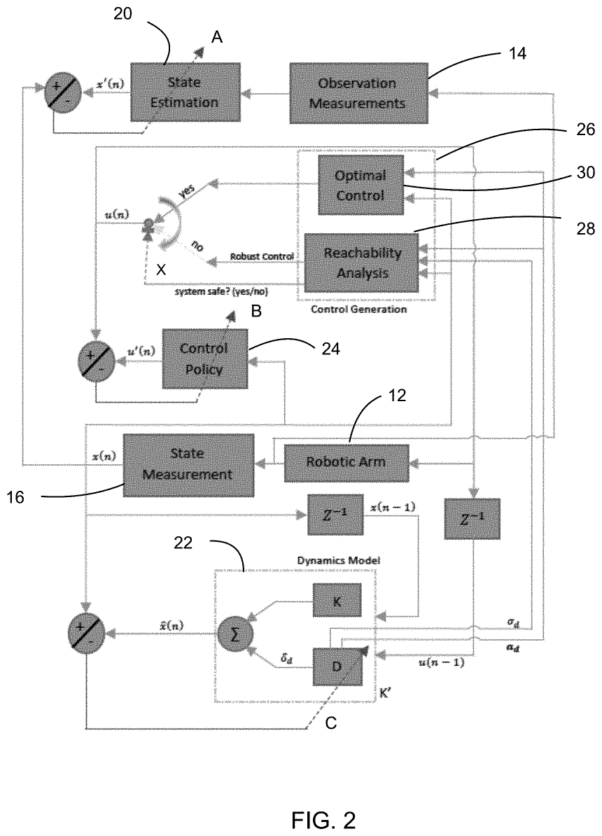

Referring to FIG. 2, a flow chart of the initial learning phase of the control and learning module 18 and its interaction with the observation system 14, measurement device 16 and the robotic arm 12 are shown. During the initial learning phase, all of the state estimation module 20, the dynamics modeling module 22, and the control policy module 24 receive their training to bring the control and learning module 18 up to a relatively safe functional level. The learning process for the three deep neural network modules are schematically demonstrated by the dotted arrows indicated by A, B and C.

During the initial learning phase, the only available information at this stage is the preliminary dynamics model K in the dynamics modeling module 22, which includes all the available information about the system dynamics of the robotic arm in isolation, with no interaction with the environment. The preliminary dynamics model K provides a prediction of current state and is created based on existing knowledge of the system dynamics of the robotic arm 12 in isolation. How the end effector of the robotic arm 12 interacts with various objects in the environment is not known in the preliminary dynamics model K. Other aspects of the environment such as the exact weight of various payloads may also be unknown.

The complementary dynamics model D is configured to learn the unknown portion of the dynamics of the robotic arm 12, not modelled by the preliminary dynamics model K, particularly the interaction between the robotic arm 12 and the environment. By incorporating existing knowledge about the system dynamics into the preliminary dynamic model K, some learning load can be removed from the complementary dynamics model D, making the initial learning phase more efficient. Therefore, it is understood that the preliminary dynamic model K may be eliminated without departing from the teachings of the present disclosure. The complementary dynamics model D includes a Bayesian neutral network where the parameters of the model are random variables. The complementary dynamics model D outputs a correction parameter that complements the output of the preliminary dynamic model K. In addition to this correction parameter, the complementary dynamics model D generates a variance which reflects the reliability and accuracy of the dynamics model accuracy over various parts of the state-space.

More specifically, the complementary dynamics model D generates three outputs: a correction parameter δ_{d}, a dynamics model variance σ_{d}, and a dynamics model parameter vector α_{d}. The correction parameter δ_{d} is used to improve the state prediction provided by the preliminary dynamics model K. The dynamic model variance σ_{d} is associated with the correction parameter δ_{d} and represents the modeling uncertainty of the complementary dynamics model D near point x(n) in the state-space. The initialization of the parameters of the complementary dynamics model D is done in a separate step where this model is tuned to generate near zero output in parts of the state-space where we have high confidence in the preliminary dynamics model K.

The dynamics model variance σ_{d}, as a measure of modeling uncertainty, is sent to the reachability analysis module 30 for reachability analysis to ensure safe performance of the robotic arm 12 in unknown environments. The reachability analysis module 28 determines whether the current state is safe or unsafe and generates a corresponding signal to control a selector switch at a node accordingly as indicated by arrow X. If the reachability analysis module 28 determines that the current state is unsafe, the reachability analysis module 28 generates a robust control command to the robot servos motors in order to maintain safe performance. If the reachability analysis module 28 determines that the current state is safe, the optimal control module 30 generates an optimal control command to robot servo motors in order to take a step towards the completion of the task assigned to the robotic arm 12.

Whether a current state is safe or unsafe is based on a predetermined safety objective/criterion stored in the reachability analysis module 28. As an example, dangerous states can be formulated depending on the given task, e.g. when the distance of the robot end effector is too close to the closest human operator in the environment. In this example, a dangerous case may be formulated as d<c where d is the distance of the end effector to the closest human operator and c is a threshold value determined by safety requirements. A dangerous state as determined through reachability analysis is one that belongs to the backward reachable set of all states corresponding to d<c. Therefore, the reachability analysis module 28 determines whether the current state resides within a backward reachable set of dangerous or undesired states.

The optimal control module 28 is configured to receive the dynamics model parameter vector α_{d} from the complementary dynamics model D of the dynamics modeling module 22 and the state measurements x(n) from the measurement device 16. The state measurement represents a measurement of actual current state by the measurement device 16. The parameters from the preliminary dynamics model K are already available to the optimal control module 28. Therefore, the optimal control module 28 generates an optimal control command u(n) to the servos of the robotic arm 12 based on the latest dynamics model (K+D) and the state measurement x(n).

To ensure that the robotic arm 12 operates safely despite the modeling uncertainties, the reachability analysis module 30 works in parallel with the optimal control module 28 and can override the optimal control command u(n) generated by the optimal control module 28, when needed. The reachability analysis module 30 is configured to receive the state measurements x(n) from the measuring device 16 and the dynamics model variance σ_{d} from the dynamics modeling module 22 and determines whether the current state is on the boundary of a backward reachable set of some undesirable (or unsafe) states. As explained earlier, dangerous states for a given task may be defined in the form of mathematical formulations, e.g. an inequality d<c ensuring of certain minimal distance, c, between the robot end effector and various objects. Reachability analysis ensures that despite the worst case dynamics model, the robot is always able to navigate away from the dangerous states. When the current state is on the boundary of a backward reachable set, it means that given the worst-case dynamics (provided by the modeling uncertainty which is quantified by the dynamics model variance) and despite any available control effort, there is still a possibility for the robot to touch upon the boundary of dangerous states i.e. d=c in the given example. When this condition is met, the robust control command generated by the reachability analysis module 30 overrides the optimal control command u(n) generated by the optimal control module 28, and the robust control command from the reachability analysis module 30 is used to control the operation of the robotic arm. When this condition is not met, the optimal control command u(n) is not overridden by the robust control command, and is paired with the state measurements, x(n), to form additional training data for the control policy module 24.

As the robotic arm 12 interacts with the environment, the complementary dynamics model D receives more training data on unseen parts of the state-space. As a result, the dynamics model variance σ_{d} that represents the modeling uncertainty of the complementary dynamics module D of the dynamics modeling module 22 gradually decreases as the complementary dynamic model D receives more training with updated training data until the modeling uncertainty diminishes. As a result, the robust control command from the reachability analysis module 30 overrides the optimal control command from the optimal control module 28 less often. Therefore, the robotic arm 12 can be operated based on the optimal control command from the optimal control module 30, and gradually expands its exploration space while at the same time the control policy module 24 evolves progressively.

In the initial learning phase, the state estimation module 20 is trained based on the state measurements x(n). The trajectories generated during the initial learning phase are dependent on the selected initial states x(0). For sufficient training in this phase, multiple trajectories need to be generated, each starting at a different initial point to expose the three deep neural networks of the state estimation module 20, the dynamics modeling module 22, and the control policy module 24 to as much training data as possible. Proper selection of these initial state values plays an important role in the learning performance. As an example, the initial states may be randomly selected with a selection probability that is a function of multiple variables including the dynamics modeling uncertainty. The objective is to expose the robotic arm 12 to parts of the state space that correspond to dynamics models that are more uncertain.

During the initial learning phase, the control policy module 24 is only subject to training and does not participate in the control of the robotic arm 12. The robotic arm 12 is controlled by a hybrid of optimal control command from the optimal control module 30 (e.g. model predictive control) and a robust control command from the reachability analysis module 30.

In summary, the state estimation module 20, the dynamics modeling module 22, and the control policy module 24 are all represented as Bayesian networks. This selection helps quantify uncertainty of each module in different parts of the state space. As explained later, during the secondary learning phase, the state estimation module 20 can provide an estimated state x′(n) and an associated variance σₓ. As an example, the state estimation module 20 can be represented as a sensor with additive noise variance σₓ. The complementary dynamics model D of the dynamics modeling module 22 generates correction parameter δ_{d} of the current state with respect to the preliminary model K, along with the associate variance parameter σ_{d}. As an example, σ_{d} represents the variance of a disturbance input to the system or reflects modeling uncertainty. This information is useful for reachability analysis for determining unsafe states. Finally, the control policy module 24 generates the control, u′(n), along with an associated uncertainty measure σᵤ, which can be interpreted as the control policy's confidence in the generated command.

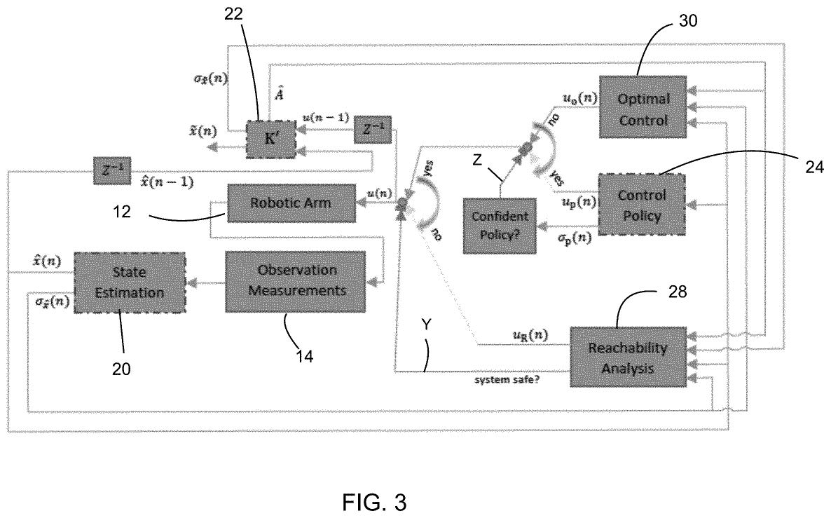

Referring to FIG. 3, a flow chart of the operations and secondary learning phase of the control and learning module 18 is shown. After the initial learning phase, the robotic arm 12 starts its normal operation to attend to its assigned task, such as an assembly task or a delivery task on a production line, while the control and learning module 18 continues to learn and modify the robotic control during normal operation of the robotic arm 12 to ensure that the automation system 10 meets certain safety and performance robustness criteria. This normal operation phase is also called operations and secondary learning phase because both the operations and the secondary learning aspects of this phase are implemented simultaneously.

In the operations and secondary learning phase, all of the uncertainty values in the initial learning phase are used to ensure of the safety and acceptable performance of the robotic arm 12 while providing a reliable platform that enables re-tuning of all the three deep learning networks of the state estimation module 20, the dynamics modeling module 22, and the control policy module 24 for improved robotic control.

The three deep neural networks in the state estimation module 20, the dynamics modeling module 22 and the control policy module 24 during the initial training phase are trained up to an acceptable level of performance such that they can operate reasonably in the operations and secondary learning phase when direct state measurements from the measuring device 16 are no longer available. In the operations and secondary learning phase, the measurement device 16 may stop providing the state measurements, and only the normal system instruments, such as the observation system 16, are available to provide observation measurements. State measurement plays no role in the secondary learning phase. State information may be extracted indirectly from the observation measurements. Although full state information is not available in the operations and secondary learning phase, the control and learning module 18 can improve all the three deep learning networks in the state estimation module 20, the dynamics modeling module 22, and the control policy module 24 based on the available observation measurements (e.g., visual data from the camera images or LiDAR data) or conventionally generated optimal/robust controls.

As previously set forth, all the deep learning networks of the state estimation module 20, the dynamics modeling module 22, and the control policy module 24 are modelled as Bayesian neural network. Therefore, in addition to their expected output, the three neural networks also provide output variance which can be used as a measure of network uncertainty.

During the second learning phase, the state estimation module 20 generates a first estimated current state, \hat{x}(n), and a variance, σ_{\hat{x}}(n), associated with the first estimated current state based on the observation measurements from the observation system 14. This variance can be interpreted as a measurement noise for the first estimated current state. A sample delayed version of the control input, u(n−1), to the robotic arm 12, along with a sample delayed estimated state, \hat{x}(n−1), are sent to the dynamics modeling module 22. The dynamics modeling module 22, which includes the preliminary dynamics model K and the complementary dynamics model D (jointly represented by K′ in FIG. 3) generates a second estimated current state, \tilde{x}(n), and an associated variance, σ_{\hat{x}}(n), which is the modeling uncertainty. The error between the first estimated current state, \hat{x}(n), and the second estimated current state, ñ(n), are back-propagated for returning both the neural networks of the state estimation module 20 and the dynamics modeling module 22 to improve their function during the normal operation of the automation system 10.

The reachability analysis module 30 is configured to evaluate the safety and, if needed, apply a robust control command to the robotic arm 12 to ensure that safe performance is maintained. The reachability analysis module 28 receives (1) the first estimated current state, \hat{x}(n), (2) the associated variance, σ_{\hat{x}}(n) (interpreted as sensor noise), (3) the latest dynamics model parameter vector, Â, and (4) the variance σ_{\tilde{x}}(t) (as a measure of the modeling uncertainty or disturbance) of the second estimated current state. The reachability analysis module 30 generates a robust control command if the current state is observed to be on the boundary of a backward reachable set for an unsafe destination state. This function is schematically demonstrated by a Boolean output (as indicated by output arrow Y) of the reachability analysis module 28 which controls a selector switch at a node. When the control and learning module 18 is deemed to be on an unsafe boundary state, a robust control command u_{R}(t) is applied to the robotic arm 12. When the control and learning module 18 is observed to be safe, either the output of a real-time calculated optimal controller uₒ(n), or the output of the control policy network, u_{P}(n), are applied to the robotic arm 12. The process on the selection between these two controls will be discussed in more detail below.

The first estimated current state \hat{x}(n) is also sent to the control policy module 24, which generates a control policy command, u_{P}(n), and a control policy variance, σ_{P}(n), associated with the control policy command. The control policy variance, σ_{P}(n), is used to quantify the confidence of the control policy module 24 in the generated control policy command. As an example, the control policy variance, σ_{P}(n), can be compared against a threshold to decide whether or not the generated control policy is trustworthy for execution on the robotic arm 12. Although the reachability analysis module 30 aims to provide safety robustness, it does not take into account the performance requirements. As such, an uncertain control policy may imply poor performance of the system in fulfilling the given task. Furthermore, reachability analysis assumes that the control is implemented in accordance with the given system model. As such, by adopting an uncertain control policy, one may also compromise safety as it may lead to irrational behavior of control policy commanding the robot in unexpected ways. When the control policy module 24 is not confident in the generated control policy command (or less confident than a predefined confidence threshold), an optimal control module 28 can take over. This is schematically demonstrated in FIG. 3 via the “confident policy?” box and the Boolean arrow Z that acts as a switch to select between control input options u_{P}(n) and uₒ(n) to a node.

The optimal control module 28 receives the latest dynamics model parameter vector Ã, the first estimated current state, \hat{x}(n), and a variance σ_{\hat{x}}(t) (as a sensor noise variance) associated with the first estimated current state, and solves for the optimal control action, uₒ(n). Solving such an optimal control problem in real-time may not be feasible. Therefore, the robotic arm 12 may be stopped or operated at a slower pace to accommodate the time needed by the optimal control module 28. This behavior is intuitive as any intelligent system is expected to stop or slow down in unfamiliar territories to further evaluate the conditions and optimize performance.

While the robotic arm 12 interacts with the environment to fulfill its assigned tasks, the control and learning module 18 also improves its performance by secondary learning. Upon the application of new optimal control command uₒ(n) to the robotic arm 12, it is paired with the first estimated current state \hat{x}(n) to form additional training data for the control policy module 24. The additional trainings of the network of the state estimation module 20 and the network of the dynamics modeling module 22 are coupled and hence, are more complex.

Given the last estimated state, \hat{x}(n−1), and the last control input u(n−1), the dynamics modeling module 22 provides a second estimated current state, \tilde{x}(n). The second estimated current state can be compared against the first estimated current state, \hat{x}(n), which is calculated based on the observation measurements. The error:

e=\hat{x}(n)−\tilde{x}(n) Equation (1)

is back-propagated to tune the parameters of the networks of the state estimation module 20 and the dynamics modeling module 22. However, there are a few potential issues with back propagating this error to tune both the networks in the state estimation module 20 and the dynamics modeling module 22 simultaneously.

The question that rises in this situation is which of the two modules are responsible for the observed error “e”? Imagine an extreme case where the network of the dynamics modeling module is currently residing at the global optima and does not require any additional re-tuning. In this case, the observed error “e” is fully rooted in the network of the state estimation module 20. As such, the dynamics modeling network parameters should be left intact while the error, e, should be back-propagated solely to the state estimation module 20 for additional tuning. Otherwise, the dynamics modeling network is forced to compensate for the limitations of the state estimation module 20 and subsequently is pushed away from its correct parameter set. The combined additional degrees of freedom of the two networks together further lead to overfitting and compromises the systems generalization performance. Furthermore, over time the functional boundaries between various modules is dissolved, forcing the whole system to work as a single unit where no clear tasks are assigned to any of the modules. This phenomenon nulls the applicability of the algorithmic steps defined earlier.

For example, the output of the state estimation module 20 can no longer be interpreted as the estimated current state since this module may partly be taking over the functionality of other modules. A modular structure can be beneficial to system performance and has the following advantages:

First, a modular network structure is easier to troubleshoot and debug as various modules can be tested in isolation and their performance can be monitored independently. Upon the detection of a defective module, improvements in the module network structure or the training data can help mitigate the problem.

Second, under a modular framework and upon the availability of new training data specific to a module, that module can be improved. For some tasks, e.g. object/landmark detection, many such training datasets are shared within the machine learning community and are growing in size with a fast pace. For example, upon the availability of additional training data for door hinge detection or gear teeth detection in an assembly task, the related module can be further trained/fine-tuned for more reliable performance.

Third, another benefit of a modular design is the flexibility to accommodate conventional techniques that have evolved over the years and have proven efficient and reliable in various applications. Optimal or robust control are examples of such techniques. The methodology proposed here and demonstrated in FIG. 3 is enabled through a modular structure.

Another aspect of the control and learning module 18 is concerned with preserving the modular structure of FIG. 3 throughout the secondary learning phase. The uncertainty information provided by each module is used to achieve this goal. To clarify this point, consider a limiting case where the dynamics modeling network is fully confident in the second estimated current state \tilde{x}(n) output from the dynamics modeling module. In this case, it is only logical to leave this network intact throughout the secondary training and solely back propagate the error, e=\hat{x}(n)−\tilde{x}(n), through the state estimation module 20. A generalization of this approach is applied here for a case where both units are uncertain in the generated output but by different levels. For this general case, it is proposed to make the gradient descent step size of the parameters of each module, a function of the corresponding uncertainty level.

Consider M={m₁,m₂}, where m₁ and m₂ are the parameter vectors associated with the state estimation and the dynamics model, respectively. Also consider the cost, C(e), a function of the error “e” given by Equation 1. The gradient of C(e) with respect to the parameter vector M is given as:

$$\frac{\partial C}{\partial M} = [ \frac{\partial C}{\partial {m}_{1}} , \frac{\partial C}{\partial {m}_{2}} ]$$

Assuming a gradient descent update, the parameter tuning for the state estimation and the dynamics model is written as:

$$\{ \begin{matrix}{m}_{1}^{′} = {m}_{1} + c {α}_{1} \frac{\partial C}{\partial {m}_{1}} \\ {m}_{2}^{′} = {m}_{2} + c {α}_{2} \frac{\partial C}{\partial {m}_{2}}\end{matrix} \qquad Equation ( 2 )$$

where c is a constant. The steps sizes α₁ and α₂ are functions of the uncertainty values associated with the state estimation and the dynamics model networks, i.e.,

$$\{ \begin{matrix}{α}_{1} = f ( {ρ}_{1} ) \\ {α}_{2} = f ( {ρ}_{2} )\end{matrix} \qquad Equation ( 3 )$$

where ρ₁ and ρ₂ are the uncertainty values, given as functions of the corresponding Bayesian network output variances, i.e.

$$\{ \begin{matrix}{ρ}_{1} = g ( {σ}_{\hat{x}} ( n ) ) \\ {ρ}_{2} = g ( {σ}_{\tilde{x}} ( n ) )\end{matrix} \qquad Equation ( 4 )$$

In one embodiment, the function g can be defined as a normalizing step given as:

$$\{ \begin{matrix}{ρ}_{1} = \frac{{σ}_{\hat{x}} ( n )}{{β}_{1}} \\ {ρ}_{2} = \frac{{σ}_{\tilde{x}} ( n )}{{β}_{2}}\end{matrix} \qquad Equation ( 5 )$$

where β₁ and β₂ are the variances of the training data outputs used so far to train the state estimation and the dynamics modeling networks, respectively.

Furthermore, the function ƒ can be defined as a softmax function of the normalized variances, i.e.,

αⱼ=2σ(ρ)ⱼ Equation (6)

where σ( )ⱼ is a softmax function and ρ can take any of the two values of the normalized variances

$${ρ}_{1} = \frac{{σ}_{\hat{x}} ( n )}{{β}_{1}} and {ρ}_{2} = \frac{{σ}_{\tilde{x}} ( n )}{{β}_{2}} .$$

When the two normalized variances ρ₁ and ρ₂ are equal, the step sizes α₁=α₂=1 where the method behaves like a normal gradient descent scheme. In any other case, one of the two modules will experience a larger step size. As is intuitively expected, in an extreme case where the uncertainty associated a module is very small, the corresponding re-tuning step size is close to zero and hence, only the module with relatively large uncertainty experiences retuning.

In another embodiment, the function ƒ can be represented as a separate network which can be trained independently. This network can receive the task network output variances at its input and generate the step size values at the output.

The control and learning module of the present disclosure provides a complete automation framework with performance and safety robustness as well as learning aspects all addressed in a systematic fashion. The techniques presented herein are general in nature and can be adopted by any automation systems, although all the concepts herein are described in relation to an example of a robotic arm with a manipulation or assembly tasks on a production line.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A control and learning module for controlling a robotic arm, comprising:
at least one learning module including at least one neural network,
wherein the at least one neural network is configured to receive and be trained by both state measurements based on measurements of current state and observation measurements based on observation data during an initial learning phase and is configured to be re-tuned by updated observation data for improved performance during an operations and secondary learning phase when the robotic arm is in normal operation and after the initial learning phase.

2. The control and learning module according to claim 1, wherein the state measurements are obtained by sensors and represent actual current state.

3. The control and learning module according to claim 1, wherein the at least one neural network is represented as a Bayesian neural network.

4. The control and learning module according to claim 1, wherein the at least one neural network is configured to generate an output relating to an output task and a variance associated with the output, the variance being a measure of uncertainty relating to reliability of the output task.

5. The control and learning module according to claim 1, wherein the at least one learning module comprises:
a state estimation module configured to provide an estimated state based on only the observation measurements; and
a dynamics modeling module configured to generate a dynamics model and a dynamics model output variance, the dynamics model output variance representing an uncertainty of the dynamics model.

6. The control and learning module according to claim 5, wherein the state estimation module is configured to output a first estimated current state and a variance associated with the first estimated current state.

7. The control and learning module according to claim 6, wherein the dynamics modeling module is configured to output a second estimated current state.

8. The control and learning module according to claim 7, wherein the state estimation module and the dynamics modeling module are each configured to receive an input relating to a difference between the first estimated current state and the second estimated current state to improve performance during the operations and secondary learning phase.

9. The control and learning system according to claim 5, wherein the estimated state includes estimated positions of obstacles and target objects in an environment.

10. The control and learning module according to claim 5, further comprising a control policy module configured to generate a control policy command and a control policy variance associated with the control policy command based on the estimated state from the state estimation module.

11. The control and learning module according to claim 10, wherein the control policy module is configured to generate the control policy command and the control policy variance only during the operations and secondary learning phase.

12. The control and learning module according to claim 10, further comprising an optimal control module configured to generate an optimal control command based on the dynamics model from the dynamics modeling module and one of the state measurements and estimated states.

13. The control and learning module according to claim 12, wherein the optimal control module is configured to override the control policy command from the control policy module when the control policy variance is larger than a predefined variance threshold value.

14. The control and learning module according to claim 13, further comprising a reachability analysis module configured to receive the state measurements, the dynamics model parameters and the associated output variance from the dynamics modeling module, and determine whether the current state is in a safe state.

15. The control and learning module according to claim 14, wherein the reachability analysis module is configured to generate a robust control command overriding the optimal control command from the optimal control module when the reachability analysis module determines that the current state is in an unsafe state.

16. The control and learning module according to claim 10, wherein the state estimation module, the dynamics modeling module, and the control policy module each include a neural network which receives training in both the initial learning phase and the operations and secondary learning phase.

17. The control and learning module according to claim 16, wherein the state estimation module, the dynamics modeling module, and the control policy module each output a variance representing uncertainty of each of the state estimation module, the dynamics modeling module, and the control policy module.

18. The control and learning module according to claim 5, wherein the dynamics modeling module includes a preliminary dynamics model and a complementary dynamics model, the preliminary dynamics model being predetermined and providing state prediction based on existing knowledge about system dynamics of the robotic arm.

19. The control and learning module according to claim 18, wherein the complementary dynamics model is configured to generate a correction parameter to correct the state prediction provided by the preliminary dynamics model.

20. The control and learning module according to claim 17, wherein the complementary dynamics model is configured to generate the dynamics model variance associated with the correction parameter.
